(19) United States
(12) Patent Application Publication
(10) Pub. No.: US 2014/0225020 A1
(43) Pub. Date: Aug. 14, 2014

(54) High Capacity Control Valve

(71) Applicant: FISHER CONTROLS INTERNATIONAL LLC, Marshalltown, IA (US)

(72) Inventor: Daniel M. Adams, Marshalltown, IA (US)

(73) Assignee: FISHER CONTROLS INTERNATIONAL LLC, Marshalltown, IA (US)

(21) Appl. No.: 13/766,339

(22) Filed: Feb. 13, 2013

(51) Int. Cl. F16K 5/08

(52) U.S. Cl. CPC F16K 5/08
USPC 251/324; 29/890.12

(57) ABSTRACT

A high capacity fluid control valve includes a valve body having a fluid inlet and a fluid outlet connected by a flow corridor, a valve seat disposed within the flow corridor the valve seat being located above a longitudinal axis of a flow pipes connected to the fluid inlet and the fluid outlet, and a valve plug disposed within the flow corridor, the valve plug cooperating with the valve seat to control fluid flow through the valve body. The valve seat is offset from the longitudinal axis of the flow pipes in a direction towards the valve plug.

### FIELD OF THE DISCLOSURE

The disclosure generally relates to fluid control valves and more specifically to high capacity fluid control valves.

### BACKGROUND OF THE DISCLOSURE

Fluid control valves control the flow of fluid from one location to another. When the fluid control valve is in a closed position, high pressure fluid on one side is prevented from flowing to a lower pressure location on the other side of the valve. Several types of control valves may be used in a given industry, these types of control valves include sliding stem valves, rotary valves, and globe valves.

Sliding stem valves are often used to control gas flow in industries such as the natural gas industry and the propane gas industry. Industries such as these have been trending towards higher capacity sliding stem valves to allow higher fluid flow rates or larger flow capacities through the valves. When sizing sliding stem valves, one constraint on the design is that industry standards dictate face to face dimensions for pipe connections of sliding stem valves up to about 16 inches. In order to maintain these stringent face to face dimensions, current high capacity sliding stem valves 10 locate a valve seat 12 at or below a centerline 14 of connecting pipes 16, as illustrated in FIGS. 1, 1A, and 1B. This configuration creates sharp turns in the fluid flow path through a flow corridor 18 that connects a fluid inlet 22 with a fluid outlet 24. These sharp turns may create turbulent areas 19 of recirculating flow, which reduce efficiency of the control valve 10. To ensure that adequate flow area exists, current high capacity sliding stem valves include semi-elliptical-shaped downstream flow corridors 20, especially downstream of the valve seat 12 (as illustrated in FIG. 1A). However, these elliptical-shaped flow paths 20 reduce flow capacities of these valves 10.

Recently angled trim valves, such as the valve 110 illustrated in FIGS. 2 and 2A, have been developed to reduce the number of turns in the fluid flow path through the flow corridor 118. However, at least some of the valve seat 112 remains below a centerline 114 of the connecting pipes 116. While angled trim valves 110 reduce the number of turns in the flow corridor 118, this angled arrangement hampers routine maintenance because the valve 110 is no longer oriented perpendicularly to the connecting pipes 116, which reduces clearance between the valve 110 and the connecting pipes 116.

### SUMMARY

In accordance with one exemplary aspect of the present invention, a high capacity fluid control valve includes a valve body having a fluid inlet and a fluid outlet connected by a flow corridor. A valve seat is disposed within the flow corridor, the valve seat being located above a longitudinal axis of flow pipes connected to the fluid inlet and the fluid outlet. A valve plug is disposed within the flow corridor, the valve plug cooperating with the valve seat to control fluid flow through the valve body. The valve seat is offset from the longitudinal axis of the flow pipes in a direction towards the valve plug.

In another exemplary aspect of the present invention, a method of reducing directional change of a fluid flowing through a high capacity fluid control valve includes providing a valve body having a fluid inlet and a fluid outlet connected by a flow corridor, providing a valve seat disposed within the flow corridor, and providing a valve plug disposed within the flow corridor, the valve plug cooperating with the valve seat to control fluid flow through the valve body. The method further includes locating the valve seat above a longitudinal axis of flow pipes that are connected to the fluid inlet and the fluid outlet

In further accordance with any one or more of the foregoing aspects, a high capacity fluid control valve (or a method of improving efficiency of a high capacity fluid control valve) may further include any one or more of the following preferred forms.

In some preferred forms, the high capacity fluid control valve may include a flow corridor downstream of the valve seat that is symmetrically-shaped about two axes. In other preferred forms, the two axes are orthogonal to one another. In yet other embodiments, the flow corridor downstream of the valve seat is round or oval or otherwise symmetrical about two axes. In yet other preferred forms, the flow corridor has a change in direction through the valve body of between 200° and 290°, preferably between 220° and 280°, more preferably between 240° and 270°, and even more preferably about 264°. In yet other preferred forms, the flow corridor has a single 90° turn within the valve body. In yet other preferred forms, the flow corridor has five changes in direction within the valve body. In still other preferred forms, a plurality of directional vanes is disposed within the flow corridor.

### BRIEF DESCRIPTION OF THE DRAWINGS

FIG. 1 is a side cross-sectional view of a prior art sliding stem valve;

FIG. 1A is a cross-sectional view of a flow corridor taken along line 1A-1A in FIG. 1;

FIG. 1B is the cross-sectional view of FIG. 1 with flow turn angles illustrated;

FIG. 2 is a cross-sectional view of a prior art angled sliding stem valve;

FIG. 2A is the cross-sectional view of the angled sliding stem valve of FIG. 2 with flow turn angles illustrated;

FIG. 3 is a side cross-sectional view of a high capacity sliding stem valve constructed in accordance with the teachings of the disclosure;

FIG. 3A is a cross-sectional view of a flow corridor taken along line 3A-3A of FIG. 3; and

FIG. 3B is the cross-sectional view of FIG. 3 with flow turn angles illustrated.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention.

### DETAILED DESCRIPTION

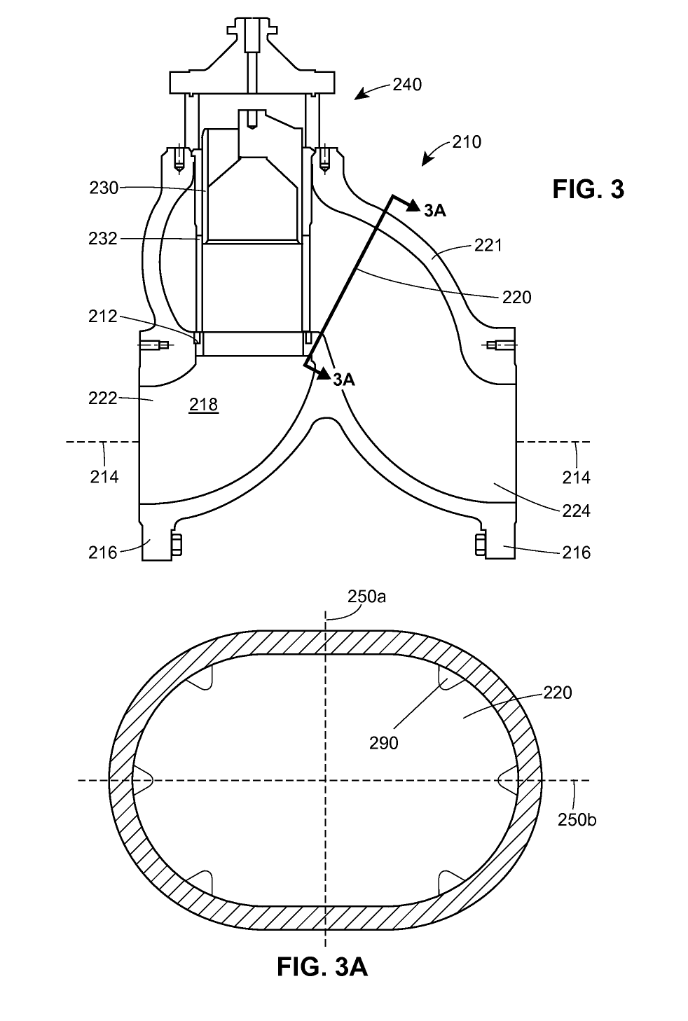

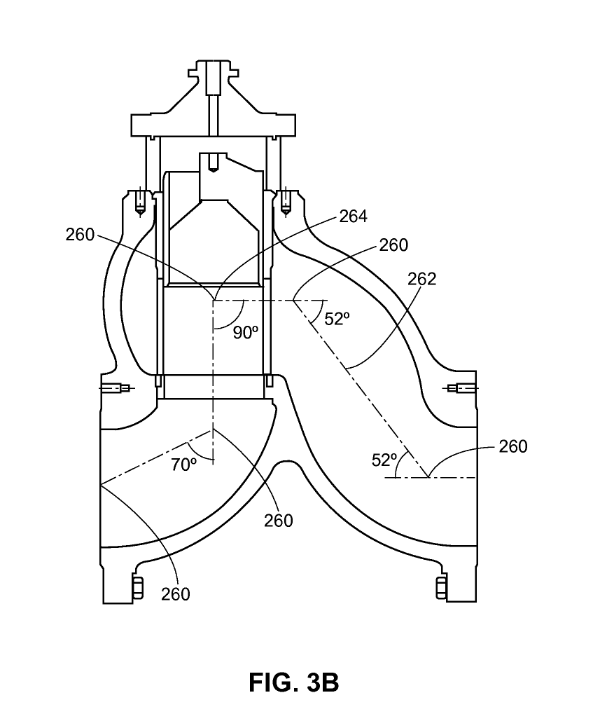

Turning now to FIGS. 3, 3A, and 3B, one embodiment of a high capacity flow valve 210 constructed in accordance with the teachings of the disclosure is illustrated. The high capacity flow valve 210 includes a valve seat 212 located in a flow corridor 218. The flow corridor 218 is defined by a hollow space within a valve body 221 that connects a fluid inlet 222 with a fluid outlet 224. The fluid inlet 222 and the fluid outlet 224 may be formed in one or more connecting pipes 216 that may be integrally formed with, or otherwise connected to, the valve body 221. The connecting pipes 216 may include a longitudinal axis 214.

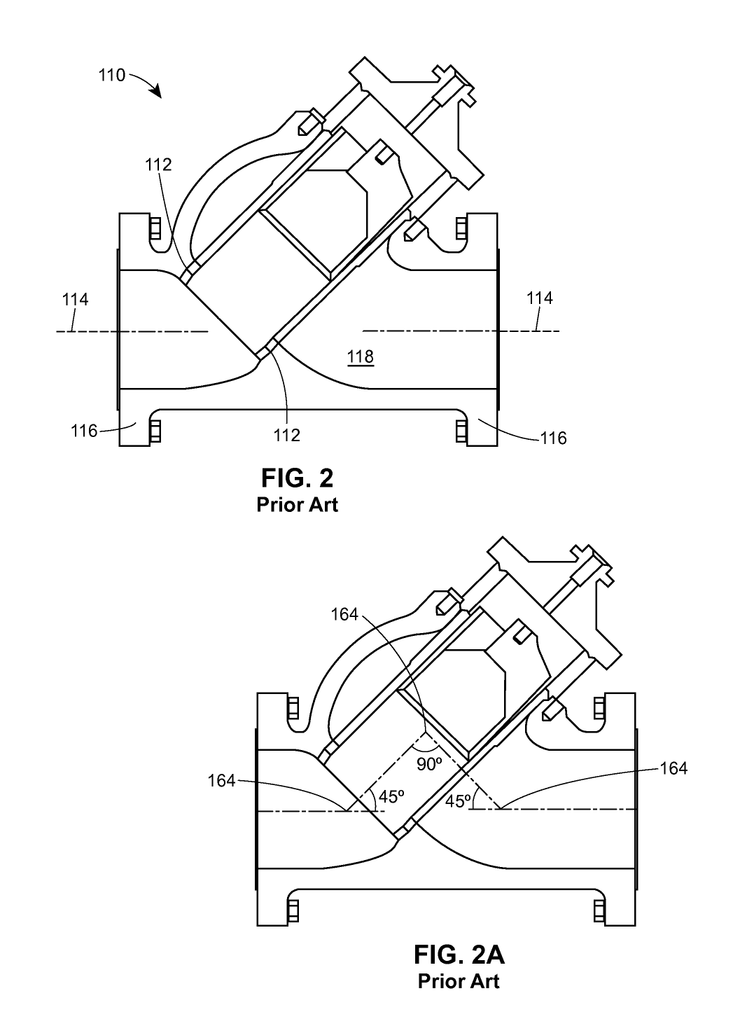

A valve plug 230 cooperates with the valve seat 212 to control fluid flow through the high capacity flow valve 210. An actuator 240 moves the valve plug 230 within the valve body 212 to control fluid flow through the valve body 212. The valve seat 212 is located above the longitudinal axis 214 (when viewed in FIG. 3), in a direction towards the valve plug 230. By raising the valve seat 212 above the longitudinal axis, towards the valve plug 230, the flow corridor 218 may be straightened (or at least less curved compared to prior art flow corridors) while still maintaining easy access to the actuator 240, to the valve plug 230 and/or to a valve cage 232 because the actuator 240, the valve plug 230, and the valve cage 232 are oriented generally perpendicular to the longitudinal axis 214 of the connecting pipes 216. Moreover, the flow corridor 218 reduces or eliminates turbulent or re-circulating areas of fluid flow. This, in turn, allows the flow corridor 218 downstream of the valve seat 212 to be more uniformly shaped, thereby providing a higher fluid flow capacity. In particular, the flow corridor 218 downstream of the valve seat 212 may have a cross-sectional shape that is symmetrical about two axes 250a, 250b that are orthogonal to one another (see FIG. 2). In some preferred embodiments, the flow corridor 218 downstream of the valve seat 212 has a round or an oval cross-sectional shape.

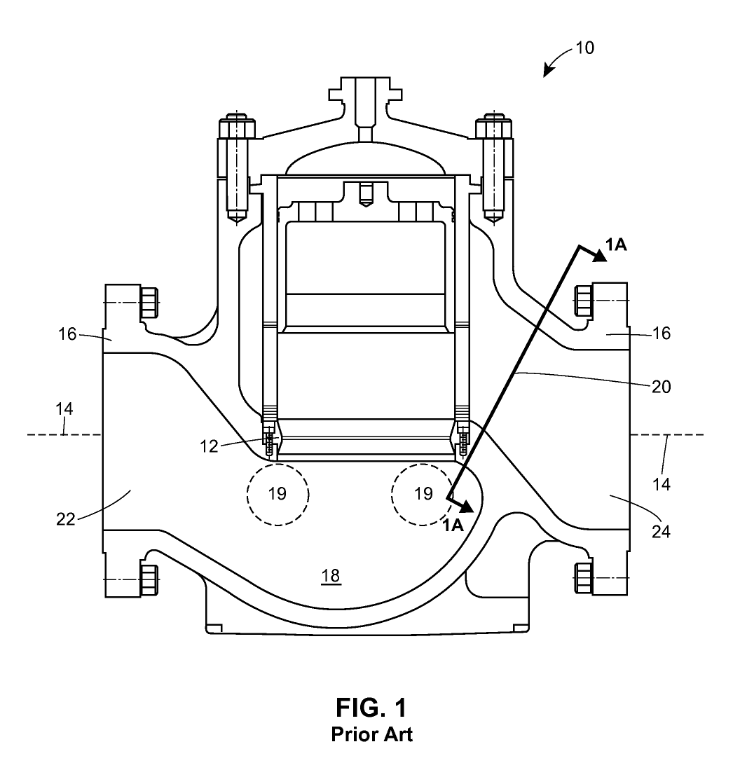

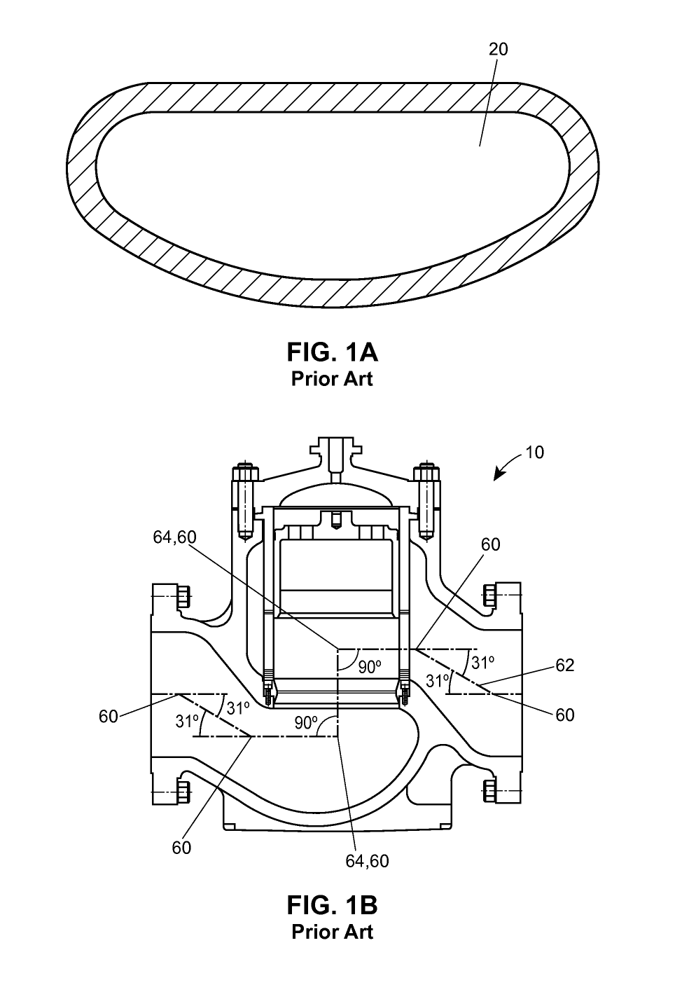

By locating the valve seat 212 above the centerline 214, the flow corridor 218 may be smoothed so that the fluid flowing through the high capacity control valve 210 may experience a total of between 200° and 290°, preferably between 220° and 280°, more preferably between 240° and 270°, and even more preferably about 264° of directional change, as illustrated in FIG. 3B. This is less directional change than a traditional control valve 10, which has about 304° of directional change (FIG. 1B). Less directional change produces less turbulence and thus more efficient fluid flow. As illustrated in FIG. 3B, the flow corridor 218 has a centerline 262 that includes a single 90° turn 264 in contrast to the control valve 10 of FIG. 1B, which includes two 90° turns 64. Furthermore, the flow corridor 218 may include 5 changes in direction 260 (FIG. 3B) while traditional control valves 10 include flow corridors 18 having six or more changes in direction 60 (FIG. 1B)

In other embodiments, the fluid flow path 218 may include directional vanes 290 (FIG. 3A) to further improve flow characteristics by assisting directional changes of the fluid flow.

Although high capacity control valves have been described herein have been described with respect to gaseous fluids, such as natural gas and propane, the disclosed high capacity control valves may be used to control other types of fluid flows.

Any of the embodiments of the high capacity control valves described herein advantageously reduce the angular changes of fluid flowing through the control valves, thus reducing turbulence and increasing efficiency. The disclosed high capacity control valves also advantageously have easily accessible valve trim and actuators.

Although certain high capacity control valves have been described herein in accordance with the teachings of the present disclosure, the scope of coverage of this patent is not limited thereto. On the contrary, while the invention has been shown and described in connection with various preferred embodiments, it is apparent that certain changes and modifications, in addition to those mentioned above, may be made. This patent covers all embodiments of the teachings of the disclosure that fairly fall within the scope of permissible equivalents. Accordingly, it is the intention to protect all variations and modifications that may occur to one of ordinary skill in the art.

What is claimed is:

1. A high capacity fluid control valve comprising:
a valve body having a fluid inlet and a fluid outlet connected by a flow corridor;
a valve seat disposed within the flow corridor, the valve seat being located above a longitudinal axis of flow pipes that are directly connected to the fluid inlet and the fluid outlet; and
a valve plug disposed within the flow corridor, the valve plug cooperating with the valve seat to control fluid flow through the valve body,
wherein the vale seat is offset from the longitudinal axis of the flow pipes in a direction towards the valve plug.

2. The high capacity fluid control valve of claim 1, wherein the flow corridor downstream of the valve seat is symmetrically-shaped about two axes.

3. The high capacity fluid control valve of claim 2, wherein the two axes are orthogonal to one another.

4. The high capacity fluid control valve of claim 3, wherein the flow corridor downstream of the valve seat has a cross-sectional shape that is one of round and oval.

5. The high capacity fluid control valve of claim 1, wherein the flow corridor has a change in direction through the valve body of between 200° and 290°.

6. The high capacity fluid control valve of claim 5, wherein the flow corridor has a change in direction through the valve body of between 220° and 280°.

7. The high capacity fluid control valve of claim 6, wherein the flow corridor has a change in direction through the valve body of between 240° and 270°.

8. The high capacity fluid control valve of claim 7, wherein the flow corridor has a change in direction through the valve body of about 264°.

9. The high capacity fluid control valve of claim 1, wherein the flow corridor has a single 90° turn within the valve body.

10. The high capacity fluid control valve of claim 1, wherein the flow corridor has only five changes in direction within the valve body.

11. The high capacity fluid control valve of claim 1, further comprising a plurality of directional vanes disposed within the flow corridor.

12. A method of reducing directional change of a fluid flowing through a high capacity fluid control valve, the method comprising:
providing a valve body having a fluid inlet and a fluid outlet connected by a flow corridor, a valve seat disposed within the flow corridor, and a valve plug disposed within the flow corridor, the valve plug cooperating with the valve seat to control fluid flow through the valve body; and
locating the valve seat above a longitudinal axis of flow pipes that are connected to the fluid inlet and the fluid outlet.

13. The method of claim 12, wherein providing includes providing a flow corridor that is symmetrical about two axes downstream of the valve seat.

14. The method of claim 13, wherein the two axes are orthogonal to one another.

15. The method of claim 12, wherein providing includes providing a flow corridor that has between 220° and 290° of directional change through the valve body.

16. The method of claim 15, wherein the flow corridor has between 240° and 280° of directional change.

17. The method of claim 16, wherein the flow corridor has about 264° of directional change.

18. The method of claim 12, wherein providing includes providing a flow corridor that has a single 90° change in direction.

19. The method of claim 12, wherein providing includes providing a flow corridor that has only five changes in direction through the valve body.

20. The method of claim 12, wherein providing includes providing a flow corridor with a plurality of directional vanes.
